(19) United States
(12) Patent Application Publication
(10) Pub. No.: US 2011/0215732 A1
(43) Pub. Date: Sep. 8, 2011

(54) BUILT-IN LAMP WIRELESS DIMMER DEVICE

(76) Inventor: Wen-Lin Chen, Yonghe City (TW)

(21) Appl. No.: 12/717,635

(22) Filed: Mar. 4, 2010

(51) Int. Cl. H05B 41/36

(52) U.S. Cl. 315/291

(57) ABSTRACT

The present invention relates to a built-in lamp wireless dimmer device, the wireless dimmer device being built into a light-emitting component, and a remote control and a switching element are used to implement a dimming function. The wireless dimmer device is primarily structured from a decoder unit and a RF (radio frequency) wireless receiver unit. Accordingly, the remote control is used to transmit a RF signal to the dimmer device to implement wireless dimming and stepless light source transformation of the light-emitting component.

### BACKGROUND OF THE INVENTION

(a) Field of the Invention

The present invention provides a built-in dimmer device, and more particularly to a built-in lamp wireless dimmer device, which enables stepless transformation of the brightness of the light source, and can directly substitute existing lamps, thereby eliminating the need for the user to change existing circuitry.

(b) Description of the Prior Art

In view of the current demand for energy conservation, a prerequisite of many electronic appliances that use energy resources is the ability to conserve energy, and the most commonly used electronic appliance used in daily life is none other than the lamplight; for example, general households, shops, and so on, all must use lamplights. Moreover, offices, department stores, exhibition venues, markets, and so on, all use a large number of lamplights, and thus the demand for a power saving lamplight is of even greater importance.

However, when the user wants to change the appearance of the light source of an existing lamplight, then he must continually change the ON/OFF states of the switch, and such switching back and forth not only easily damages the switch, moreover, such repeated switching actions wastes energy and physical strength. Furthermore, operation of such dimmer devices is confined to switching of wall switches, thus the user must time and time again walk to the switch to operate, making such a dimmer device extremely inconvenient.

### SUMMARY OF THE INVENTION

A primary objective of the present invention lies in: a wireless dimmer device provided with a stepless dimming function that is built into a light-emitting component, the dimmer device being structured from a decoder unit and a RF (radio frequency) wireless receiver unit, and the decoder unit and the RF wireless receiver unit are mutually electrically connected. Moreover, the decoder unit is electrically connected to a DIM control, and the DIM control is at the same time electrically connected to a main controller. In which, the user can use a remote control to implement wireless remote control of the dimmer device. When the remote control emits a wireless RF signal, then the RF wireless receiver unit receives and transmits the signal to the decoder unit for decoding, after completing decoding, the decoder unit immediately transmits the decoded signal to the DIM control to control change. After which the main controller controls light source transformation of the light-emitting component. According to the art described above, the present invention provides a breakthrough in solving the existing problems of dimmer devices for LED (light-emitting diodes) lamps of the prior art, including the extreme inconvenience when the user wants to change the appearance of the light source of existing lamplights, at which time he must continually change the ON/OFF states on the switch, and such switching back and forth not only easily damages the switch, moreover, such repeated switching actions wastes energy and physical strength. Furthermore, operation of such dimmer devices is confined to switching of wall switches, thus the user must time and time again walk to the switch to operate, The present invention achieves the breakthrough by eliminating the need for the user to walk to a wall switch to operate the dimmer device by using the RF wireless receiver unit to receive wireless signals, thus, the user needs only to use a remote control to transmit RF wireless signals, which the RF wireless receiver unit receives, thereby enabling dimming and light source transformation of the light-emitting component to be controlled, as well as realizing the practical advancements of time-saving and effort-saving.

Another objective of the present invention lies in: the decoder unit being further electrically connected to a switching receiver unit, and the switching receiver unit is electrically connected to a switching element. Hence, when the remote control is not within reach of the user or temporarily misplaced, then the user can use the switching element directly to implement stepless light source transformation of the light-emitting component.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a cutaway view of a preferred embodiment of the present invention.

FIG. 2 is a block schematic flow chart of the preferred embodiment according to the present invention.

FIG. 3 is an implementation schematic view of the preferred embodiment according to the present invention.

FIG. 4 is an implementation schematic view I of another preferred embodiment according to the present invention.

FIG. 5 is an implementation schematic view II of the another preferred embodiment according to the present invention.

### DETAILED DESCRIPTION OF THE PREFERRED EMBODIMENTS

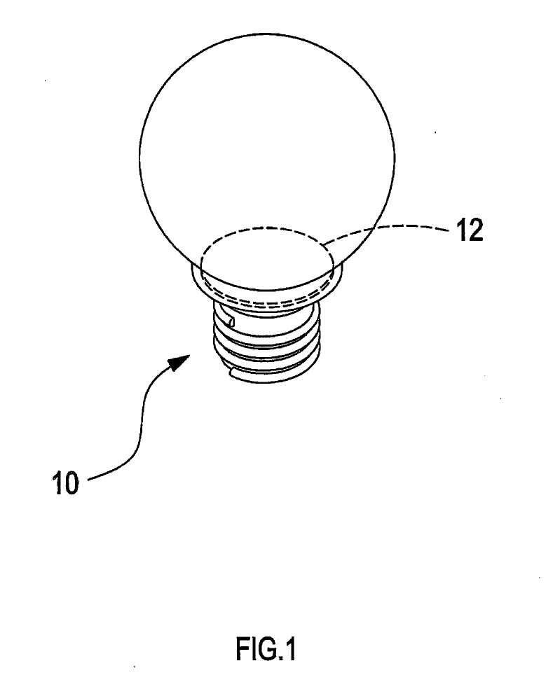

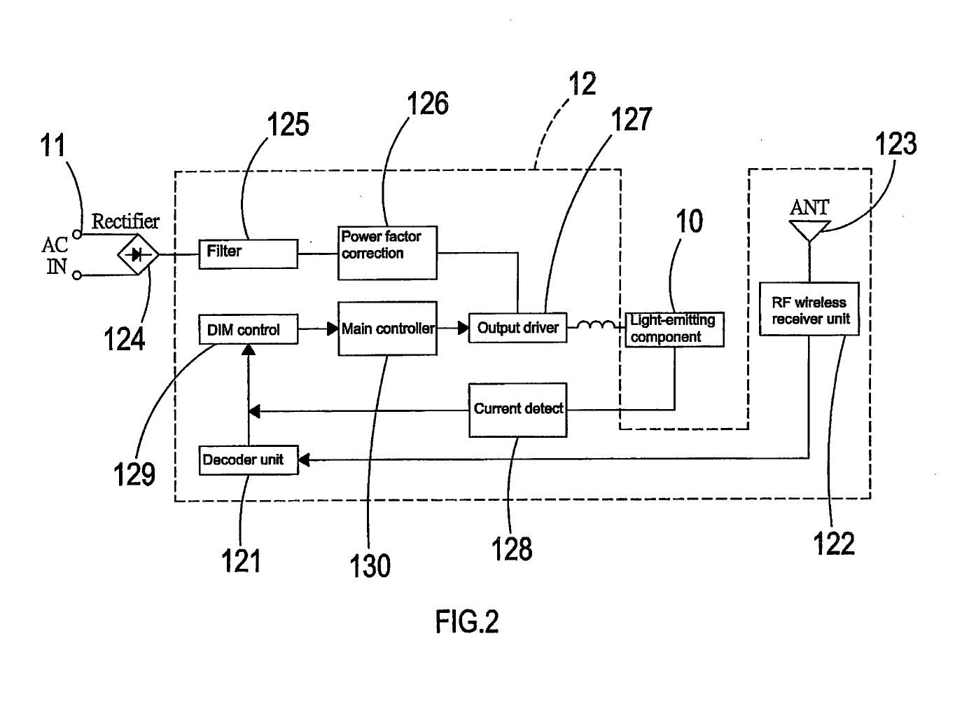

Referring to FIG. 1 and FIG. 2, which show a cutaway view and a block schematic flow chart respectively of a preferred embodiment according to the present invention, and it can be clearly seen from the drawings that the present invention primarily comprises a light-emitting component 10 (the light-emitting component 10 can be either a fluorescent lamp or a LED (light-emitting diode) lamp), and the light-emitting component 10 is electrically connected to a switching element 11. The switching element 11 enables controlling opening or closing or dimming of the light-emitting component 10, and a dimmer device 12 provided with a stepless dimming function is fitted within the light-emitting component 10.

The dimmer device 12 primarily comprises a decoder unit 121, and the decoder unit 121 receives signals transmitted from the undermentioned RF (radio frequency) wireless receiver unit 122 to implement conversion of the signals, whereupon the decoded signals are passed on to enable adjusting light source transformation of the light-emitting component 10. The decoder unit 121 is electrically connected to the RF wireless receiver unit 122 to enable receiving RF wireless signals therefrom. And decoding is implemented on the RF wireless signals transmitted to the decoder unit 121. The RF wireless receiver unit 122 is further fitted with an antenna 123.

Furthermore, the dimmer device 12 further comprises a rectifier 124 electrically connected to the switching element 11, a filter 125 electrically connected to the rectifier 124, a power factor correction 126 electrically connected to the filter 125, an output driver 127 electrically connected to the power factor correction 126, in which the output driver 127 enables activating the light-emitting component 10 to actuate emitting light therefrom, a current detect 128, which is electrically connected to the light-emitting component 10, a DIM control 129, which receives signals from the decoder unit 121, and a main controller 130, which receives signals from the DIM control 129, and at the same time controls the output driver 127.

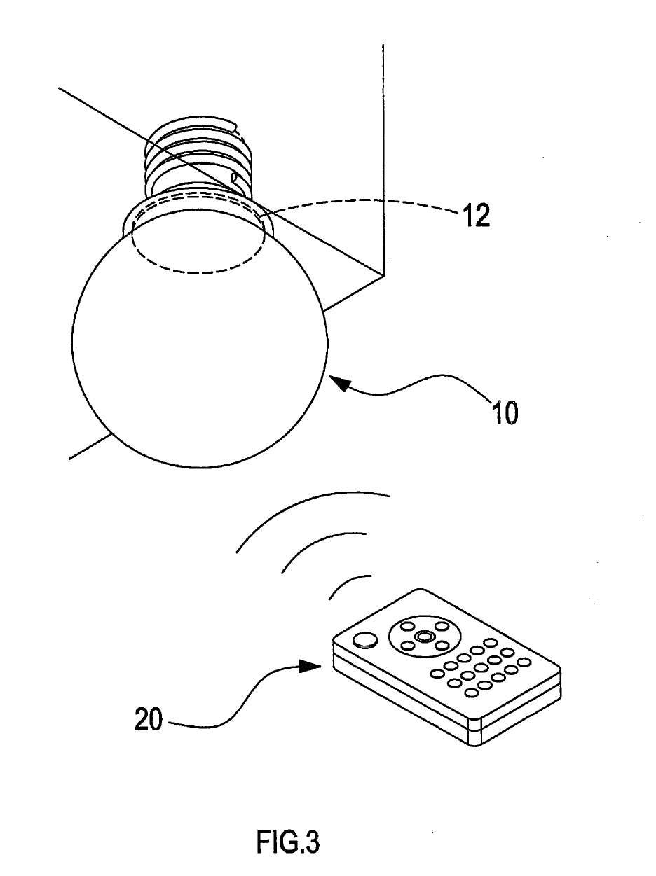

According to the aforementioned structure and constructional design, circumstances during operational use of the present invention are described hereinafter. Referring together to FIG. 2 and FIG. 3, which show the block schematic flow chart and an implementation schematic view respectively of the preferred embodiment according to the present invention, and it can be clearly seen from the drawings that the RF wireless receiver unit 122 is able to receive RF signals from a remote control 20. Accordingly, the user is able to wirelessly remote control the dimmer device 12 using the remote control 20 to implement stepless dimming. In which, when the user uses the remote control 20 to control dimming, at the same time the remote control 20 is pressed, then a RF wireless signal received by the antenna 123 is immediately transmitted RF to the wireless receiver unit 122. The RF wireless receiver unit 122 sends the signal to the decoder unit 121, where decoding thereof is carried out, after which the decoded signal to transmitted to the DIM control 129. The DIM control 129 is then used to transmit the signal to the main controller 130 to implement controlling light source transformation of the light-emitting component 10.

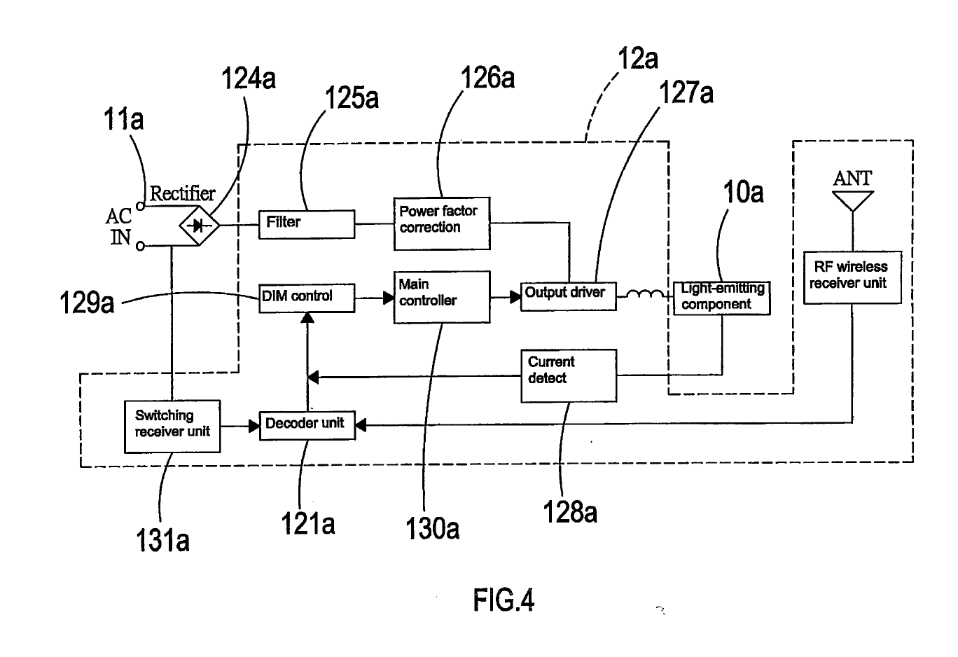

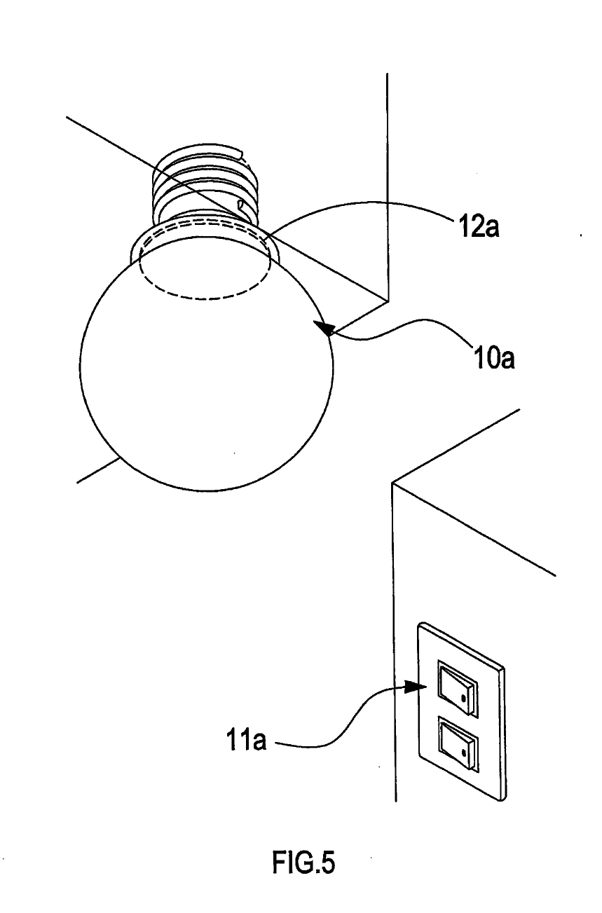

Referring to FIG. 4 and FIG. 5, which show implementation schematic views I and II respectively of another preferred embodiment according to the present invention, and it can be clearly seen from the drawings that a dimmer device 12a further comprises a switching receiver unit 131a electrically connected to a switching element 11a and a rectifier 124a, in which the rectifier 124a is electrically connected to a filter 125a, and the filter 125a is electrically connected to a power factor correction 126a. The power factor correction 126a is electrically connected to an output driver 127a, in which the output driver 127a enables activating a light-emitting component 10a to actuate emitting light therefrom, and the light-emitting component 10a is electrically connected to a current detect 128a. Furthermore, the switching receiver unit 131a enables receiving signals from the switching element 11a, and the decoder unit 121a electrically connected to the switching receiver unit 131a is used to decode the signals and transmit the decoded signals to a DIM control 129a, after which a main controller 130a is used to implement controlling light source transformation. Accordingly, when the user opens the switching element 11a, then the light-emitting component 10a immediately lights up. If the user opens the element 11a a second time after closing thereof, then the switching receiver unit 131a receives the signal from the switching element 11a and retransmits it to the decoder unit 121a, whereupon the DIM control 129a and the main controller 130a process the decoded signal from the decoder unit 121a. Accordingly, stepless transformation (gradual dimming, or gradual brightening) of the light source of the light-emitting component 10a commences, after which, pressing the switching element 11a again stops light source transformation of the light-emitting component 10.

Hence, referring to all the drawings, the present invention has the following advantages:

1. Using the RF wireless receiver unit 122 to receive signals eliminates the need for the user to walk to a wall switch to operate the dimmer device 12, and only needs to use the remote control 20 to transmit a RF wireless signal for the RF wireless receiver unit 122 to receive and control the light-emitting component 10 to implement dimming and light source transformation, thereby realizing the practical advancements of time-saving and effort-saving.

2. When the remote control 20 is not within reach of the user or temporarily misplaced, then the user can use the switching element 11 directly to implement stepless light source transformation of the light-emitting component 10, thus providing extreme convenience.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A built-in lamp wireless dimmer device, comprising:
a light-emitting component, the light-emitting component is electrically connected to a switching element;
a dimmer device provided with stepless dimming function built into the light-emitting component, the dimmer device comprising:
a decoder unit, the decoder unit receives signals transmitted from a RF (radio frequency) wireless receiver unit to implement conversion of the signals, whereupon the decoded signals are passed on to enable adjusting light source transformation of the light-emitting component, and
a RF wireless receiver unit, the RF wireless receiver unit is electrically connected to the decoder unit, and enables receiving RF wireless signals, the RF wireless signals are transmitted to the decoder unit to implement decoding.

2. The built-in lamp wireless dimmer device according to claim 1, wherein the light-emitting component is either a fluorescent lamp or a LED (light-emitting diode) lamp.

3. The built-in lamp wireless dimmer device according to claim 1, wherein the RF wireless receiver unit receives RF signals from a remote control.

4. The built-in lamp wireless dimmer device according to claim 1, wherein the dimmer device further comprises:
a rectifier electrically connected to the switching element;
a filter electrically connected to the rectifier;
a power factor correction electrically connected to the filter;
an output driver electrically connected to the power factor correction, the output driver enables activating the light-emitting component to actuate emitting light therefrom;
a current detect electrically connected to the light-emitting component;
a DIM control, the DIM control enables receiving signals from the decoder unit;
a main controller, the main controller enables receiving signals from the DIM control, and simultaneously controls the output driver.

5. The built-in lamp wireless dimmer device according to claim 1, wherein the RF wireless receiver unit is further fitted with an antenna.

6. The built-in lamp wireless dimmer device according to claim 1, wherein the dimmer device is provided with a switching receiver unit, and the switching receiver unit enables receiving signals from the
